(19) United States
(12) Patent Application Publication
(10) Pub. No.: US 2010/0066674 A1
(43) Pub. Date: Mar. 18, 2010

(54) Cursor controlling apparatus and the method therefor

(75) Inventors: Sheng-Chun Chueh, Xindian City (TW); Wei-Jen Huang, Xindian City (TW); Hung-Yi Lin, Xindian City (TW)

Correspondence Address: BACON & THOMAS, PLLC, 625 SLATERS LANE, FOURTH FLOOR, ALEXANDRIA, VA, 22314-1176, US

(73) Assignee: IdeaCom Technology Corporation, Hsin Tien (TW)

(21) Appl. No.: 12/382,507

(22) Filed: Mar. 18, 2009

(30) Foreign Application Priority Data
Sep. 16, 2008 (TW) 097135468

(51) Int. Cl. G09G 5/08

(52) U.S. Cl. 345/158

(57) ABSTRACT

The invention relates to a cursor controlling apparatus for controlling a cursor according to an input information comprising an input module, a processing module and a controlling module. The input module is used for generating the input information. The processing module coupled to the input module is used for generating processing data according to the input information. The controlling module is coupled to the processing module for comparing the processing data with a predetermined value to generate a comparing result and further generating a first control signal or a second control signal corresponding to the processing data and the compared result to control the cursor respectively.

### BACKGROUND OF THE INVENTION

1. Field of the Invention

The invention is related to a cursor controlling apparatus, and more specifically related to a cursor controlling apparatus for automatically detecting different operation modes according to the pressure on the touch panel executed by a finger of user.

2. Description of the Prior Art

Various kinds of touch sensing technology are used in many different electronic products in recently years for its growing in better quality and more convenient. A touch pad is implemented in various kinds of electronic products because it has advantages in size small, cost less, power low and life durable. User can control the cursor moving in absolute coordinate displayed on the screen by moving his finger or using a stylus on the flat pad correspondingly. In general, a user needs to control an additional mouse to move the cursor in the relative coordinate on the screen of the electronic products. Therefore, the user needs to control both the touch pad and the mouse to control the cursor moving in absolute coordinate and the relative coordinate on the screen respectively. However, it is inconvenient to allocate both the touch pad and the mouse in the same electronic product since it doesn't fit the trend of small size design for the electronic products.

In addition to the manner for controlling the cursor by the touch pad and the mouse described above, there is another kind of touch pad which comprises two operation modes such as an absolute coordinate mode and a relative coordinate mode. This kind of touch pad further comprises a control button for controlling the cursor in absolute coordinate or in relative coordinate. But it has disadvantage in its complicate manual when operating the control button and in inconvenience for user.

Another manner for controlling the cursor moving in absolute coordinate and the relative coordinate is shown as U.S. Pat. No. 6,061,051, entitled “Command set for touchpad pen-input mouse”, which uses command of the computer system to control pen-input mouse to switch operation between the absolute coordinate mode and the relative coordinate mode. However, this kind of manner must add many computer commands, so it concerns the compatibility of the electronic products.

According to the defects of the prior arts described above, how to provide a fast and convenient switching method and apparatus for switching and controlling the cursor moving between the absolute coordinate mode and the relative coordinate mode is an important matter in developing the cursor controlling technology.

### SUMMARY OF THE INVENTION

It is therefore a primary objective of the present invention to provide a cursor controlling apparatus and method therefor for auto-detecting the user operation between the absolute coordinate operation mode or the relative coordinate operation mode according to the pressure executed on the touch pad by the user and switching there between to control the movement of the cursor.

One embodiment of the present invention provides a cursor controlling apparatus for controlling a cursor corresponding to an input information. The cursor controlling apparatus comprises an input module, a processing module and a controlling module. The input module is used for generating the input information. The processing module coupled to the input module is used for generating processing data according to the input information. The controlling module is coupled to the processing module for comparing the processing data with a predetermined value to generate a compared result and generating a first control signal or a second control signal according to the processing data and the compared result to control the cursor respectively. Accordingly the processing data further includes a specific value, if the specific value larger than the predetermined value, the controlling module generates the first control signal according to the processing data, otherwise, the controlling module generates the second control signal.

The present invention further discloses a cursor controlling method for controlling a cursor corresponding to an input information comprising: generating the input information; generating processing data according to the input information; comparing the processed data with a predetermined value to generate a compared result; generating a first control signal or a second control signal according to the processing data and the compared result and then controlling the cursor according to the first control signal or the second control signal respectively. Accordingly the processing data further includes a specific value, if the specific value larger than the predetermined value, generates the first control signal according to the processing data, otherwise, generates the second control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an embodiment of the cursor controlling apparatus according to the present invention.

FIG. 2 is a schematic diagram of another embodiment of the cursor controlling apparatus according to the present invention.

FIG. 3 is a flowchart diagram of an embodiment of the cursor controlling method according to the present invention.

### DETAILED DESCRIPTION

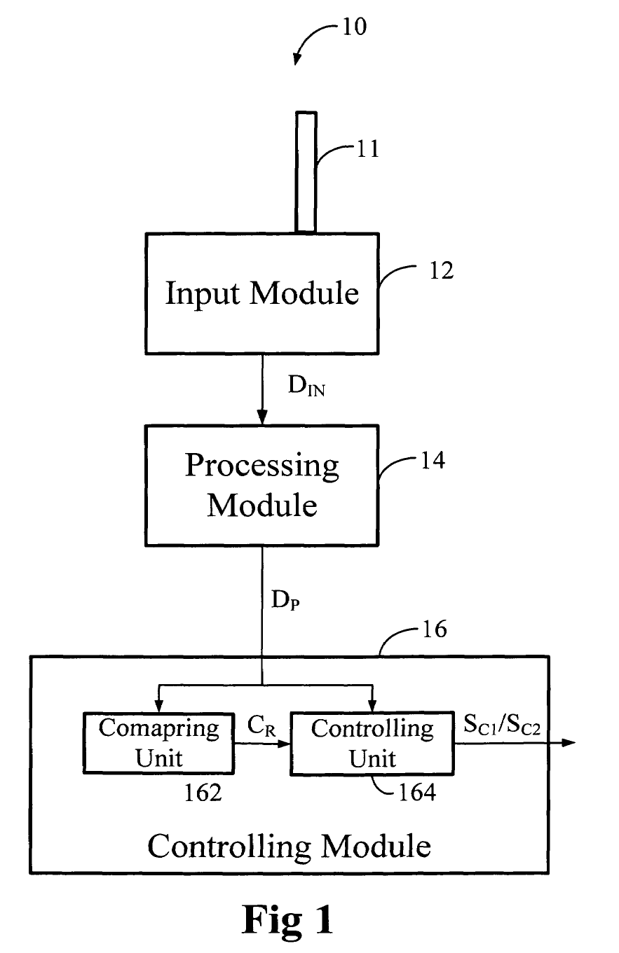

Please referring to FIG. 1, FIG. 1 is a schematic diagram of an embodiment of the cursor controlling apparatus according to the present invention. As shown in FIG. 1, the present invention is a cursor controlling apparatus 10 for controlling a cursor according to an input information. The cursor controlling apparatus 10 comprises an input module 12, a processing module 14 and a controlling module 16. The input module 12 is used for generating the input information D_{IN}. The processing module 14 coupled to the input module 12 is used for generating a processing data D_{P} according to the input information D_{IN}. The controlling module 16 coupled to the processing module 14 is used for comparing the processing data D_{P} with a predetermined value to generate a compared result C_{R}. The controlling module 16 further generates a first control signal S_{C1} or a second control signal S_{C2} corresponding to the processing data D_{P} and the compared result C_{R} and then controls the cursor according to the first control signal S_{C1} or the second control signal S_{C2} respectively. The processing data D_{P} further includes a specific value and a trace information. In one of the embodiments, the specific value is a pressure value of the processing data D_{P}. When the pressure value is larger than the predetermined value, the controlling module 16 generates the first control signal S_{C1} corresponding to the trace information. When the pressure value is less than or equal to the predetermined value, the controlling module 16 generates the second control signal S_{C2} corresponding to the trace information.

In one of the embodiments, the controlling module 16 comprises a comparing unit 162 and a controlling unit 164. The comparing unit 162 coupled to the processing module 14 compares the specific value (pressure value) of the processing data D_{P} with the predetermined value to generate the comparing result C_{R}. The controlling unit 164 coupled to the comparing unit 162 and the processing module 14 generates the first control signal S_{C1} or the second control signal S_{C2} corresponding to the trace information and the comparing result C_{R} respectively. In one of the embodiment, the first control signal S_{C1} is used for controlling the cursor moving in the absolute coordinate corresponding to the trace information of the processing data D_{P}. The second control signal S_{C2} is used for controlling the cursor moving in the relative coordinate corresponding to the trace information. The cursor controlling apparatus 10 controls the moving operation mode of the cursor according to the pressure value and controls the moving position or the movement trace of the cursor according to the trace information.

In one of the embodiments, the input module 12 is a touch pad or a touch panel. Furthermore, the touch panel is a resistive touch panel. User can use the input tool 11 to input the input information D_{IN} to the input module 12. The input tool 11 is the finger of the user or a stylus for example. Besides, the processing module 14 transmits the processing data D_{P} to the controlling module 16 by a transmitting interface (not shown) which is selected from Universal Series Bus (USB), PS2 interface, RS-232 interface, UART interface, SPI interface or the I²C interface.

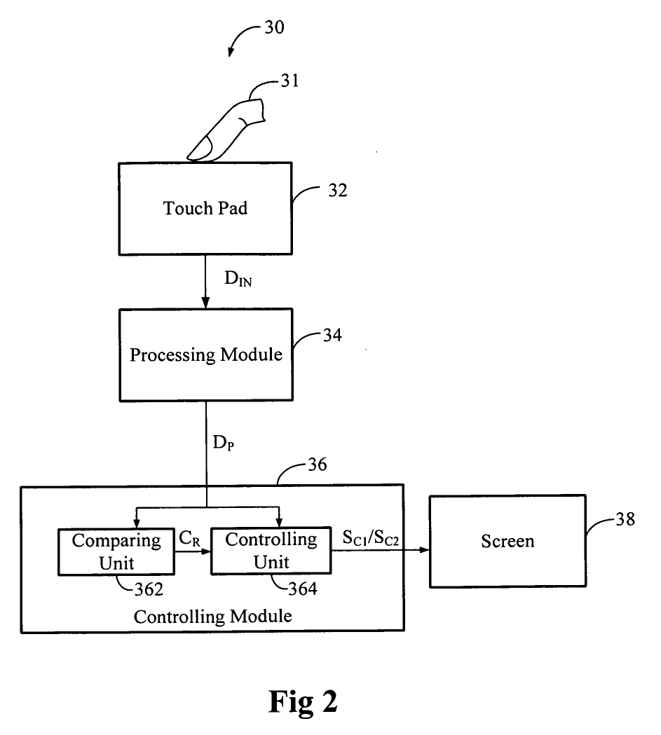

Please refer to the FIG. 2, FIG. 2 is a schematic diagram of another embodiment of the cursor controlling apparatus according to the present invention. As shown in the FIG. 2, the input module of the cursor controlling apparatus 30 is a touch pad 32, the input tool is the finger 31 of the user and the cursor is displayed on a display screen 38. The input information D_{IN} is generated by a pressing operation or a moving operation that executed on the touch pad 32 via the finger 31 of the user. The trace information is generated by the pressing position of the pressing operation or the movement trace of the moving operation executed on the touch pad 32 by the user. The specific value is the pressure value of the pressing operation or the moving operation executed on the touch pad 32 by the finger 31 of the user. When the user executes the pressing operation or moving operation by the finger 31, the touch pad 32 generates the input information D_{IN} corresponding to the pressing operation or moving operation. The processing module 34 generates a processing data D_{P} corresponding to the input information D_{IN}. In this moment, the processing module 34 transfers the input information D_{IN} with an analog signal form to the processing data D_{P} with a digital signal form for executing the following actions thereafter.

When the controlling module 36 receives the processing data D_{P} from the processing module 34, the comparing unit 362 of the controlling module 36 compares the pressure value of the processing data D_{P} with a predetermined value. If the pressure value is larger than the predetermined value, the controlling unit 364 of the controlling module 36 generates the first control signal S_{C1} under a first operation mode according to the trace information. On the other hand, if the pressure value is less than the predetermined value, the controlling unit 364 generates the second control signal S_{C2} under a second operation mode according to the trace information. Finally, the controlling module 36 further controls the cursor displayed the screen 38 according to the first control signal S_{C1} or the second control signal S_{C2} respectively.

When the pressure value is larger than predetermined value, the controlling module 36 controls the cursor under the first operation mode automatically. The first operation mode is the general manner that controls the cursor by the touch pad. Under the first operation mode, the controlling module 36 controls the cursor moving in the absolute coordinate by the first control signal S_{C1} corresponding to the trace information. Otherwise, under the second operation mode, the controlling module 36 controls the cursor moving in the relative coordinate by the second control signal S_{C2} corresponding to the trace information.

The following description is used for explaining different trace information in two different embodiments. If the user executes pressing operation but not the moving operation on the touch pad 32, the trace information is the pressing position that the user pressed on the touch pad 32 by the finger 31 or the stylus. In this moment, the controlling module 36 controls the cursor corresponding to the pressing position. If the user executes the moving operation on the touch pad 32, the trace information is the movement trace that the user pressed and moved on the touch pad 32 by the finger 31 or the stylus. In this condition, the controlling module 36 controls the cursor corresponding to the movement trace.

As the description above, the cursor controlling apparatus 30 of this invention determines to control the cursor moving under the first operation mode (touch pad control mode) or the second operation mode (mouse control mode). And then, the cursor controlling apparatus 30 controls the position or the movement of the cursor according to the trace information under the determined operation mode. Therefore, the cursor controlling apparatus 30 can detect the pressure pressed on the touch pad 32 by the user and automatically switches between two operation modes respectively to control the cursor.

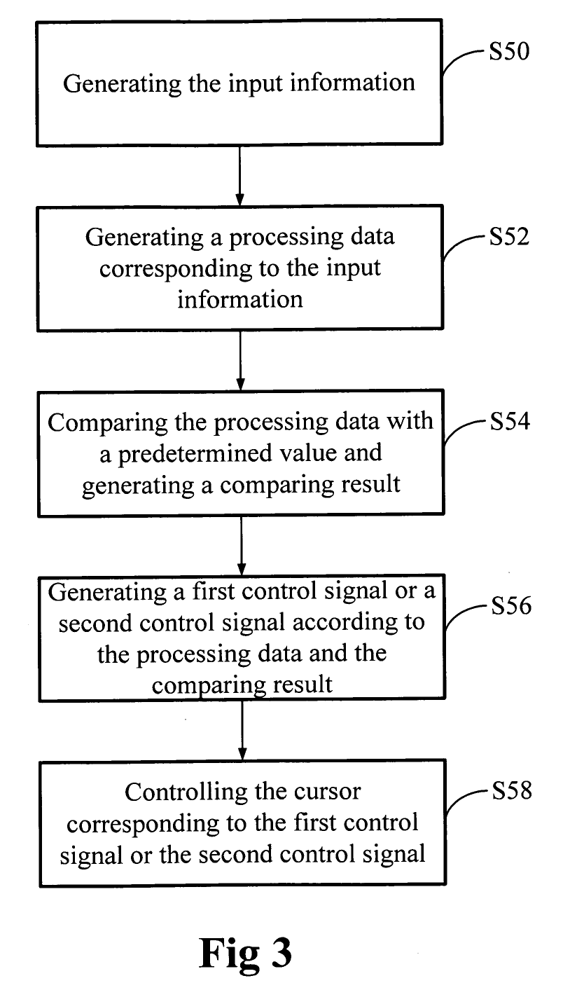

Please refer to the FIG. 3, FIG. 3 is a flowchart diagram of an embodiment of the cursor controlling method according to the present invention. As shown in the FIG. 3, the present invention is a cursor controlling method for controlling a cursor corresponding to an input information. The cursor controlling method comprises the following steps:

Step 50: Generating the input information. In one embodiment, the input information is generated corresponding to a pressing operation or a moving operation executed by a user via an input tool. The input module is a touch pad or a touch panel and the input tool 11 is the finger of the user or a stylus.

Step 52: Generating a processing data according to the input information. The processing data includes a specific value and a trace information. In one embodiment, the specific value is a pressure value of the processing data. The pressure value is generated by a pressing operation or a moving operation executed on the input module via the input tool by the user. The trace information is generated by the pressing position of the pressing operation or the movement trace of the moving operation executed on the input module by the user.

Step 54: Comparing the processing data with a predetermined value and generating a compared result.

Step 56: Generating a first control signal or a second control signal corresponding to the processing data and the comparing result. When the specific value is larger than the predetermined value, the cursor controlling method generates the first control signal according to the trace information. Otherwise, when the specific value is less than or equal to the predetermined value, the cursor controlling method generates the second control signal according to the trace information.

Step 58: Controlling the cursor corresponding to the first control signal or the second control signal. In one of the embodiment, the first control signal controls the cursor moving under the absolute coordinate or the relative coordinate corresponding to the trace information. As the manner of the touch pad to control the cursor, in the first operation mode, the first control signal control the cursor moving in the absolute position under the absolute coordinate. In the second operation mode, the second control signal controls the cursor moving in the relative position under the relative coordinate as the manner of the mouse to control the cursor.

As mentioned above, the present invention provides a cursor controlling apparatus comparing the pressure value with a predetermined value by the comparing unit of the controlling module therein. When the pressure value is larger than the predetermined value, the cursor controlling apparatus is set to a touch pad operation mode by the controlling module to control the cursor moving under the absolute coordinate corresponding to the movement trace on the touch pad executed by the user. If the pressure value is less than or equal to the predetermined value, the cursor controlling apparatus is set to a mouse operation mode by the controlling module to control the cursor moving under the relative coordinate. Accordingly, the cursor controlling apparatus can auto detects the user want to operate the touch pad under the mouse operation mode or the touch pad operation mode and then switches to the detected operation mode immediately. The cursor controlling apparatus and the method therefor can solve the disadvantages of the prior art and convenience in switching between the mouse operation and the touch pad operation mode can also be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A cursor controlling apparatus for controlling a cursor according to an input information, comprising:
an input module for generating the input information;
a processing module coupled to the input module for generating a processing data according to the input information; and
a controlling module coupled to the processing module for comparing the processing data with a predetermined value to generate a compared result and further generating a first control signal or a second control signal corresponding to the processing data and the comparing result,
wherein the processing data includes a specific value, when the specific value is larger than the predetermined value, the controlling module generates the first control signal corresponding to the processing data, when the specific value is less than or equal to the predetermined value, the controlling module generates the second control signal corresponding to the processing data.

2. The cursor controlling apparatus of claim 1, wherein the controlling module comprises:
a comparing unit coupled to the processing module for comparing the specific value with the predetermined value and generating the comparing result; and
a controlling unit coupled to the comparing module and the processing module for generating the first control signal or the second control signal corresponding to the processing data and the comparing result.

3. The cursor controlling apparatus of claim 2, wherein the specific value is a pressure value of the processing data.

4. The cursor controlling apparatus of claim 3, wherein the processing data further includes a trace information, the controlling module generates the first control signal or the second control signal corresponding to the trace information and the comparing result.

5. The cursor controlling apparatus of claim 4, wherein the first control signal controls the cursor moving in an absolute coordinate corresponding to the trace information.

6. The cursor controlling apparatus of claim 4, wherein the second control signal controls the cursor moving in a relative coordinate corresponding to the trace information.

7. The cursor controlling apparatus of claim 4, wherein the input module generates the input data according to a pressing operation or a moving operation which is executed on the input module via a input tool used by a user.

8. The cursor controlling apparatus of claim 7, wherein the pressure value is the pressure that the user executed the pressing operation or the moving operation on the input module via the input tool.

9. The cursor controlling apparatus of claim 7, wherein the trace information is a pressing position that the user executed the pressing operation via the input tool on the input module.

10. The cursor controlling apparatus of claim 7, wherein the trace information is the movement trace that the user executes the moving operation via the input tool on the module.

11. The cursor controlling apparatus of claim 7, wherein the input module is a touch pad or a touch panel.

12. The cursor controlling apparatus of claim 7, wherein the input tool is a finger of a user or a stylus.

13. A cursor controlling method for controlling a cursor corresponding to an input information, which comprising the following step:
(a) generating the input information;
(b) generating a processing data according to the input information;
(c) comparing the processing data with a predetermined value and generating a comparing result;
(d) generating a first control signal or a second control signal corresponding to the processing data and the compared result; and
(e) controlling the cursor corresponding to the first control signal or the second control signal;
wherein the processing data includes a specific value, when the specific value is larger than the predetermined value, the step (e) generates the first control signal corresponding to the processing data, when the specific value is less than or equal to the predetermined value, the step (e) generates the second control signal corresponding to the processing data.

14. The cursor controlling method of claim 13, wherein the specific value is a pressure value of the processing data.

15. The cursor controlling method of claim 14, wherein the processing data further includes a trace information, step (e) generates the first control signal or the second control signal corresponding to the trace information and the comparing result.

16. The cursor controlling method of claim 14, wherein the first control signal controls the cursor moving in an absolute coordinate corresponding to the trace information.

17. The cursor controlling method of claim 14, wherein the second control signal controls the cursor moving in a relative coordinate corresponding to the trace information.

18. The cursor controlling method of claim 15, wherein the step (a) generates the input data according to a pressing operation or a moving operation that a user executes on the input module.

19. The cursor controlling method of claim 18, wherein the pressure value is the pressure of the pressing operation or the moving operation on the input module executed by the user.

20. The cursor controlling method of claim 18, wherein the trace information is a processing position of the pressing operation that the user executed on the input module.

21. The cursor controlling method of claim 18, wherein the trace information is the movement trace of the moving operation that the user executed on the input module.

22. The cursor controlling method of claim 18, wherein the input module is a touch pad or a touch panel.
